(19) United States
(12) Patent Application Publication
(10) Pub. No.: US 2003/0225767 A1
(43) Pub. Date: Dec. 4, 2003

(54) Computerized information kiosk network

(76) Inventors: Ian Guy Archibald, Edmonton (CA); Moses Chun Kit Lee, Edmonton (CA)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/161,122

(22) Filed: May 31, 2002

(51) Int. Cl. G06F 17/30

(52) U.S. Cl. 707/10

(57) ABSTRACT

A computerized information kiosk network includes a database containing information files provided by a multiplicity of information providers. A server is accessible through communications links. A plurality of computerized information kiosk stations are linked via the communications links and the server to the database. Each of the kiosk stations have a satellite memory in which selected information files from the database are stored. The kiosk stations are capable of displaying any of the information files from the database which are stored in the satellite memory. The server includes an information provider interface through which any one of the multiplicity of information providers can, upon entering a security access code, enter and change information in the information files in the database which originated from said information provider identified by the security access code thereby creating a changed information file.

### FIELD OF THE INVENTION

The present invention relates to a computerized information kiosk network.

### BACKGROUND OF THE INVENTION

Computerized information kiosks are found in a variety of locations such as airports and shopping malls. They provide a medium to place information before the public. Included in the information that the kiosks provide is commercial information in the form of advertisements.

Information, including advertisements, is generally updated with update disks by service personnel who attend each individual kiosk location. However, kiosks are now being provided with communications links which enable the information to be updated by service personnel from a remote location. SUMMARY OF THE INVENTION

What is required is an computerized information kiosk network which will further reduce the need for intervention by service personnel.

According to the present invention there is provided a computerized information kiosk network which includes a database containing information files provided by a multiplicity of information providers. A server is accessible through communications links. A plurality of computerized information kiosk stations are linked via the communications links and the server to the database. Each of the kiosk stations have a satellite memory in which selected information files from the database are stored. The kiosk stations are capable of displaying any of the information files from the database which are stored in the satellite memory. The server includes an information provider interface through which any one of the multiplicity of information providers can, upon entering a security access code, enter and change information in the information files in the database which originated from said information provider identified by the security access code thereby creating a changed information file.

With the computerized information kiosk network, as described above, all routine placement and updates of information are handled by the information provider clients themselves through the network. Intervention is only required by service personnel for situations not contemplated when the computerized information kiosk network is established.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 is a flow diagram illustrating a computerized information kiosk network in accordance with the teachings of the present invention.

### DETAILED DESCRIPTION OF THE PREFERRED EMBODIMENT

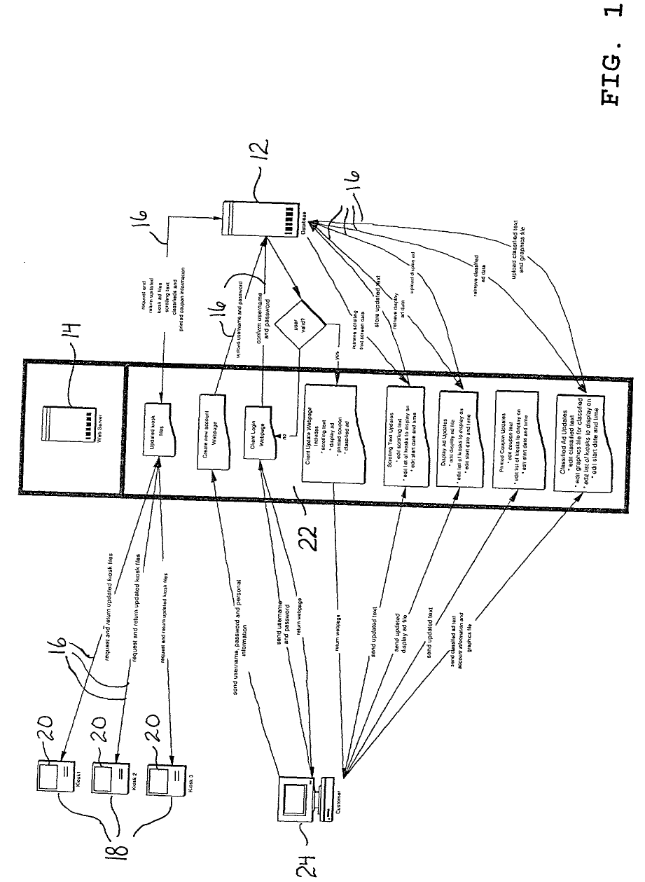

The preferred embodiment, a computerized information kiosk network generally identified by reference numeral 10, will now be described with reference to FIG. 1.

Structure and Relationship of Parts:

Referring to FIG. 1, there is provided a computerized information kiosk network 10 which includes a database 12 which contains information files provided by a multiplicity of information providers, including advertisers. A server 14 is also provided that is accessible through communications links 16. A plurality of computerized information kiosk stations 18 are linked via communications links 16 and server 14 to database 12. Communications links 16 are made through the internet at kiosk interface 20. Although communications links through the world wide web are preferred, communications links can be made through one or more of any number of media, including, but not limited to modem connections, POTS, and satellite. Each kiosk station 18 has a satellite memory in which selected information files from database 12 are stored. Kiosk stations 18 are capable of displaying any of information files from database 12 which are stored in their satellite memory. Information files can include display advertisements, scrolling text advertisements, classified advertisements or promotion coupon advertisements. Furthermore, kiosk stations 18 have printing capabilities, thereby permitting information to be printed. Server 14 includes an information provider interface 22 through which any one of multiplicity of information providers can, upon entering a security access code, enter and change information in information files in database 12 which originated from said information provider as identified by the security access code thereby creating a changed information file.

The use and operation of computerized information kiosk network 10 will now be described with reference to FIG. 1. Referring to FIG. 1, with computerized information kiosk network 10, as described above, all routine placement and updates of information files are handled by information provider clients themselves via the computerized information kiosk network 10. Intervention is only required by service personnel for situations not contemplated when computerized information kiosk network 10 is established.

In order to use computerized information kiosk network 10, any one of multiplicity of information providers, using a computer 24 for example, can access information provider interface 22 of server 14, and upon enter a security access code, enter and change information in information files in database 12 which originated from said information provider as identified by the security access code thereby creating a changed information file. The changed information file may be downloaded to any ones of the kiosk stations 18 that the information provider directs.

Each of kiosk stations 18 are capable of displaying any 10 of information files from database 12 which are stored in their satellite memory. Kiosk stations 18 have printing capabilities, selected information such as coupons, can be printed out from kiosk station 18.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope of the invention as hereinafter defined in the claims.

The embodiments of the invention in which an exclusive property or privilege is claimed are defined as follows:

1. A computerized information kiosk network, comprising:
a database containing information files provided by a multiplicity of information providers;
a server accessible through communications links;
a plurality of computerized information kiosk stations linked via the communications links and the server to the database, each of the kiosk stations having a satellite memory in which selected information files from the database are stored, the kiosk stations being capable of displaying any of the information files from the database which are stored in the satellite memory; and
the server including an information provider interface through which any one of the multiplicity of information providers can, upon entering a security access code, enter and change information in the information files in the database which originated from said information provider identified by the security access code thereby creating a changed information file.

2. The computerized information kiosk network as defined in claim 1, wherein the communications links are through the internet.

3. The computerized information kiosk network as defined in claim 1, wherein the multiplicity of information providers are advertisers.

4. The computerized information kiosk network as defined in claim 1, wherein the kiosk stations have printing capability, thereby permitting information to be printed.

5. The computerized information kiosk network as defined in claim 3, wherein the information includes at least one of display advertisements, scrolling text advertisements, classified advertisements or promotion coupon advertisements.

6. The computerized information kiosk network defined in claim 1, wherein the information providers are able to select which of the multiplicity of kiosk stations will have the changed information file downloaded from the database via the server and communications links to their satellite memory.

7. A computerized information kiosk network, comprising:
a database containing advertising files provided by a multiplicity of advertisers;
a webserver accessible through communication links forming part of the world wide web;
a plurality of computerized information kiosk stations linked via the communications links and the webserver to the database, each of the kiosk stations having a satellite memory in which selected advertising files from the database are stored, the kiosk stations being capable of displaying any of the advertising files from the database which are stored in the satellite memory; and
the webserver including an advertisers interface through which any one of the multiplicity of advertisers can, upon entering a security access code, enter and change the advertising files in the database which originated from said advertisers identified by the security access code thereby creating a changed advertising file.

8. The computerized information kiosk network as defined in claim 7, wherein the kiosk stations have printing capability, thereby permitting information to be printed.

9. The computerized information kiosk network as defined in claim 7, wherein the advertising files contain at least one of: display advertisements, scrolling text advertisements, classified advertisements or promotion coupon advertisements.

10. The computerized information kiosk network defined in claim 7, wherein the information providers are able to select which of the multiplicity of kiosk stations will have the changed advertising file downloaded from the database via the server and communications links to their satellite memory.
